(19) United States
(12) Patent Application Publication
(10) Pub. No.: US 2025/0389839 A1
(43) Pub. Date: Dec. 25, 2025

(54) METHOD FOR PERFORMING AN ULTRA-WIDEBAND-BASED RANGING MEASUREMENT WITH AT LEAST ONE OTHER ROAD USER

(71) Applicant: Robert Bosch GmbH, Stuttgart (DE)

(72) Inventors: Guillaume Jornod, Bern (CH); Keno Garlichs, Braunschweig (DE); Maximilian Stark, Hamburg (DE); Nico Ostendorf, Hannover (DE); Tobias Frye, Braunschweig (DE)

(21) Appl. No.: 19/233,475

(22) Filed: Jun. 10, 2025

(30) Foreign Application Priority Data
Jun. 19, 2024 (DE) 10 2024 205 639.1

(51) Int. Cl. G01S 13/76; G08G 1/01; G08G 1/16; H04W 4/02; H04W 4/40

(52) U.S. Cl. CPC G01S 13/765; G08G 1/0133; G08G 1/16; H04W 4/023; H04W 4/40

(57) ABSTRACT

A method for performing an ultra-wideband-based ranging measurement of a road user with at least one other road user. The method includes: exchanging status information using a V2X message signal with at least one other road user, wherein an item of status information comprises at least one indicator with respect to a capability for ultra-wideband-based ranging measurement using ultra-wideband technology of the particular road user; sending a request from the road user to the other road user for performing the ultra-wideband-based ranging measurement with the at least one other road user, wherein the message is sent in particular according to a potentially dangerous traffic situation with respect to the two road users; activating the ultra-wideband technology of the road user for performing the ultra-wideband-based ranging measurement with the at least one other road user based on a received response from the other road user with respect to the request.

### CROSS REFERENCE

The present application claims the benefit under 35 U.S.C. § 119 of German Patent Application No. DE 10 2024 205 639.1 filed on Jun. 19, 2024, which is expressly incorporated herein by reference in its entirety.

### FIELD

The present invention relates to a method for performing an ultra-wideband-based ranging measurement with at least one other road user. The present invention furthermore relates to a computer program, a device, and a storage medium for this purpose.

### BACKGROUND INFORMATION

According to official reports, the number of traffic accidents is not decreasing. Current vehicles are already equipped with emergency braking assistants, but their sensors are limited by backlight, interference or obstructions. In order to reduce such accidents, V2X or radio communication can be used, which has the advantage of functioning even without direct line of sight. So that road users can locate one another and prevent a collision, today's systems use an absolute GNSS position. However, these positions are often too inaccurate, in particular in urban environments, or only available with cheap GNSS receivers, so that effective accident avoidance cannot be guaranteed.

It is an object of the present invention to at least partially remedy the disadvantages of the related art described above. In particular, it is an object of the present invention to make a technical solution for activating an ultra-wideband technology possible.

### SUMMARY

The present invention relates to a method, a computer program, a device, and a computer-readable storage medium, as well as a message and a data carrier signal. Features and details of the present invention are disclosed herein. Features and details that are described in connection with the method according to the present invention of course also apply in connection with the computer program according to the invention, the device according to the invention, and the computer-readable storage medium according to the present invention, and vice versa in each case, so that mutual reference can also always be made with regard to the disclosure of the present invention.

The present invention relates to a method for performing an ultra-broadband-based ranging measurement of a road user with at least one other road user. According to an example embodiment of the present invention, the method includes the following steps, which are carried out in particular by the one road user:
exchanging status information using a V2X message signal between the road user and the at least one other road user, wherein an item of status information comprises at least one indicator with respect to a capability for ultra-wideband-based ranging measurement using ultra-wideband technology of the particular road user,
sending a request from the road user to the other road user for performing the ultra-wideband-based ranging measurement with the at least one other road user, wherein the message is sent in particular according to a potentially dangerous traffic situation with respect to the two road users,
activating the ultra-wideband technology of the road user for performing the ultra-wideband-based ranging measurement with the at least one other road user on the basis of a received response from the other road user with respect to the request.

This has the advantage of greater accuracy when determining distance and position between vehicles. Furthermore, this makes a more flexible and adjustable distance measurement strategy possible, so that road users, in particular vehicles, can adjust their distance measurement methods to the availability of the UWB technology on other devices. This flexibility can be particularly useful in environments where satellite positioning signals such as, for example, GPS are not readily available or reliable, such as, e.g., in urban areas with tall buildings or in the vicinity of sources of electronic interference, as a result of which a position or position indication in a V2X message signal becomes inaccurate. Thus, the method according to the invention makes possible a more robust and effective UWB-based distance measurement system that can work seamlessly with V2X technology in order to provide improved collision avoidance capabilities between road users.

According to an example embodiment of the present invention, it can be provided that the UWB technology can be made available as a so-called UWB tag or as a UWB unit.

It can be provided that the particular road user comprises a vehicle or an unprotected road user, in particular a so-called vulnerable road user. UWB or ultra-wideband is a radio technology that uses very low energy levels for short-range, high-bandwidth communications over a large portion of the radio spectrum. UWB technology or capability refers to the capability of road users, particularly their devices, to carry out functions that require wide bandwidth and precise positioning with minimal interference. UWB technology is particularly characterized by its capability for determining the position of objects, devices or road users with centimeter accuracy. This makes the use of this technology possible for real-time positioning systems, e.g. in traffic situations or scenarios, in industrial automation, in smart homes or in healthcare. UWB can be operated with very low power consumption and is therefore ideal for use in battery-powered devices such as mobile phones and wearables. The wide bandwidth and unique signal characteristics of UWB make interception difficult and provide an additional layer of security for data transmission.

Due to its wide bandwidth and the nature of its signal, UWB is less likely to interfere with other radio bands, making it a good neighbor in the crowded spectrum.

Devices with UWB capability can leverage these properties for applications such as close-proximity data transmission, precise location tracking in complex environments and secure communication channels for connected devices.

An ultra-wideband unit or UWB tag is a device that uses ultra-wideband (UWB) technology in order to accurately locate and track objects, people or road users. These tags emit short pulses across a wide frequency spectrum, so that their exact position can be determined with high accuracy indoors or in other environments. UWB tags can be used, e.g., for tracking inventory, monitoring security in factories or locating people in emergency situations. They are a key component in various applications that rely on accurate locating and tracking.

According to an example embodiment of the present invention, it is possible that the method comprises the following further steps:
exchanging a set of parameters for configuring the ultra-wideband technology to be used with the at least one other road user using unicast-based communication or groupcast-based communication,
configuring the ultra-wideband technology on the basis of the set of parameters of the other road user,
providing the ultra-wideband technology for the ultra-wideband-based ranging measurement by the particular road user.

According to an example embodiment of the present invention, it is possible that the feature of exchanging a set of parameters for configuring the ultra-wideband technology used with at least one other road user, vehicle or pedestrian via unicast-based communication or groupcast-based communication offers advantages such as the ability to ensure compatibility and synchronization between different road users, vehicles or pedestrians using unique parameters, which in turn increases the accuracy and reliability of distance measurements. This makes possible a more flexible configuration of the ultra-wideband technology based on the capabilities and parameters of other devices or road users, as a result of which the distance measurement process is optimized. Furthermore, this makes it possible for more efficient communication between road users to be provided, since it eliminates the need for multiple exchanges and adjustments of parameters, which reduces complexity and improves the overall performance of the invention.

Groupcast is a form of communication in which data are transmitted from a sender to a group of receivers. The data are sent simultaneously to a plurality of recipients which belong to a certain group. Groupcast can be considered a subcategory of multicast, wherein the focus is on specific groups.

Unicast refers to point-to-point communication in which data are transmitted from a single sender to a single receiver. Each transmission is carried out directly between two devices, wherein a unique destination address such as, e.g., an IP address can be used.

Broadcast-based communication is a method of data transmission in networks in which data are sent from a single sender to all possible receivers within a certain network or network segment. In contrast to unicast and groupcast, where data transmission is carried out to specific recipients or groups of recipients on a targeted basis, broadcast is directed to all devices in the network.

According to an example embodiment of the present invention, it is also possible that during the exchange, the status information contains a common indication valid for the road users for configuring the ultra-wideband-based technology of the particular road user, and the method comprises the following further steps:
generating a set of parameters for configuring the ultra-wideband technology to be used on the basis of the valid, common indication,
configuring the ultra-wideband technology to be used on the basis of the generated set of parameters,
providing the ultra-wideband technology for the ultra-wideband-based ranging measurement by the road users.

This has the advantage of configuring the UWB technology of each road user, in particular of each vehicle or each so-called vulnerable road user (VRU), in a mutually consistent manner, which makes more accurate ranging measurements possible. This is particularly advantageous in applications where precise distance measurements are required, such as, e.g., in urban environments.

This makes it possible for a set of parameters for configuring the UWB technology to be automatically generated based on the shared status information, as a result of which the complexity is reduced and the efficiency of the distance measurement process is increased. Furthermore, this makes intelligent activation of UWB technology possible, so that road users, in particular vehicles and VRUs, can adjust to changing conditions and optimize their distance measurement accordingly. The mutual configuration of UWB technology also makes possible a more accurate representation of the environment, which facilitates better decision-making for collision avoidance.

A “vulnerable road user” (VRU) can be understood as either a “traffic unit at risk” or “road user at risk”. This term covers all road users who are particularly vulnerable in road traffic because they are exposed to a higher risk of injury or death in the event of an accident. This includes, in particular, pedestrians, cyclists or persons using bicycles or similar two-wheeled vehicles without a motor, motorcyclists or users of micromobility, i.e. persons using electric scooters, skateboards or similar devices.

It is also possible that the valid, common indication comprises a configuration parameter and/or a road user identifier in order to generate a set of parameters for configuring the ultra-wideband technology of the road user that is to be used.

This has the advantage that the feature makes a more precise configuration of the UWB technology possible, allowing customized distance measurements and improved distance accuracy. This can be achieved, in particular, by including a configurable parameter and/or an identifier of the road user, such as a vehicle identifier, in the common indication, which generates a unique set of parameters for the configuration of the UWB technology used by the road user, such as, e.g., the vehicle. Furthermore, this makes it possible to facilitate more efficient communication between road users such as, for example, vehicles and unprotected road users, since it makes the exchange of relevant information with respect to a traffic situation possible and puts road users in the position of adjusting their distance measurement methods accordingly.

According to an example embodiment of the present invention, it is possible that the method further comprises the following step:
recognizing the potentially dangerous traffic situation with respect to the two road users in order to send the request to perform the ultra-wideband-based ranging measurement, wherein the potentially dangerous traffic situation is specified by the occurrence of an intersecting lane with the other road user and/or by a relative distance to the other road user that is smaller than a defined threshold value for the road user and/or by inaccurate satellite positioning in an item of status information of a radio message and/or by a limitation of one or more sensors, in particular of the road user.

An advantage of this feature is that it makes it possible for the invention to recognize potentially dangerous traffic situations between two road users and to send a request to perform a ranging measurement on an ultra-wideband basis. This is achieved by recognizing the occurrence of an intersecting lane with another road user and/or ascertaining a relative distance to the other road user that is smaller than a predefined threshold value for the first road user. This advantageously improves the capability of the invention for recognizing potential collisions and thus increases overall safety in road traffic.

According to an example embodiment of the present invention, it is also possible that the method comprises the following further steps:
performing the ultra-wideband-based ranging measurement by the particular road user in order to ascertain a more accurate distance between the two road users,
adjusting the action of a particular road user in real time on the basis of the ascertained distance in order to avoid the potentially dangerous traffic situation.

According to an example embodiment of the present invention, it is possible that this feature will make more accurate ranging measurements between road users possible, so that vehicle actions can be adjusted in real time in order to avoid potentially dangerous traffic situations. This advantage can be particularly important in urban environments or other areas where precise ranging measurements are critical to ensuring safety. This makes it possible to accurately measure distances with the aid of UWB technology and makes a more effective strategy for collision avoidance possible, which ultimately leads to a safer and more efficient traffic network.

According to an example embodiment of the present invention, it is further possible that the V2X message signal comprises a cooperative environment message and/or a message for the perception of vulnerable road users and/or a specific ranging measurement message.

According to an example embodiment of the present invention, it is possible to provide a cooperative environment message (CAM message) and/or a message for recognizing vulnerable road users (VAM message) and/or a specific ranging measurement message (URM message) that makes it possible for a road user to exchange information about the presence or direction of movement of the other road user along with their intentions. This makes more effective collision avoidance possible by taking into account the dynamics of the environment and the actions of all involved. By exchanging information about their own state and intentions, road users can gain a more comprehensive picture of the environment or a traffic situation and thus reduce ambiguities and uncertainties with respect to their own behavior in the traffic situation. Furthermore, the information exchanged makes it possible for road users to take into account the movements and actions of other road users and thus make more proactive and forward-looking decisions. By taking into account the presence and intentions of all road users involved, collisions can be better predicted and prevented, which reduces the risk of accidents.

According to an example embodiment of the present invention, it is possible that the status information comprises further information about the particular road user regarding their current position and/or direction of movement and/or speed.

This has the advantage that the status information comprises additional information about the current position, direction of movement or speed of each road user involved. This makes a more accurate and timely recognition of potential collisions possible, as a result of which safety increases and accidents are avoided. Furthermore, this makes a more comprehensive understanding of the situation of road users possible, so that the road users can react accordingly. For example, if a road user is moving in a certain direction, this can be taken into account when determining the distance to another road user. This information can be used to adjust the detection process, so that the invention remains accurate and reliable even in complex urban environments. In addition, this makes a better prediction of potential collisions possible, since it takes into account not only the distance between road users but also their relative movements and speeds. This proactive approach for avoiding collisions can significantly reduce the risk of accidents and increase overall safety in road traffic.

According to an example embodiment of the present invention, it is possible for the method according to the present invention to be used in a vehicle. In particular, the method can be used, for example, to avoid accidents by intelligently activating the switch from V2X to UWB technology when a potentially dangerous situation is recognized, as a result of which, for example, fewer false braking actions and more meaningful braking actions can be initiated. In other words, the accuracy of an emergency braking function in a vehicle, for example, can be significantly improved as a result. The vehicle may be configured, for example, as a motor vehicle and/or passenger vehicle and/or autonomous vehicle. The vehicle may comprise a vehicle mechanism, for example for providing an autonomous driving function, and/or a driver assistance system. The vehicle mechanism may be designed to at least partially automatically control and/or accelerate and/or brake and/or steer the vehicle.

The present invention also relates to a computer program, in particular a computer program product, comprising commands which, when the computer program is executed by a computer, cause the computer to carry out the method according to the present invention. The computer program according to the present invention thus delivers the same advantages as have been described in detail with reference to a method according to the present invention.

The present invention also relates to a device for processing data that is configured to carry out the method according to the present invention. For example, a computer which executes the computer program according to the invention can be provided as the device. The computer can have at least one processor for executing the computer program. A non-volatile data memory can also be provided, in which the computer program is stored and from which the computer program can be read by the processor for execution.

The present invention can also relate to a computer-readable storage medium which comprises the computer program according to the invention and/or commands which, when executed by a computer, cause the computer to carry out the method according to the present invention. The storage medium is formed, for example, as a data memory such as a hard drive and/or a non-volatile memory and/or a memory card. The storage medium can be integrated into the computer, for example.

Furthermore, the method according to the present invention can also be designed as a computer-implemented method. Alternatively or additionally, at least one of the disclosed method steps of the present invention can be computer-implemented and/or performed automatically.

The present invention further relates to a message for transmission in a radio communication system, comprising at least one data field that represents an indicator with respect to a capability for ultra-wideband-based ranging measurement using ultra-wideband technology, wherein the message is preferably designed
as a cooperative environment message, in particular as a CAM message, or
as a message for the perception of vulnerable road users, in particular as a VAM message, or
as a specific ranging measurement message, in particular as a URM message.

Furthermore, the present invention relates to a data carrier signal, in particular a radio signal, which transmits the above message.

Further advantages, features and details of the present invention can be found in the following description, in which exemplary embodiments of the invention are described in detail with reference to the drawings. The features mentioned in the claims and in the description can be essential to the present invention in each case, either individually or in any combination.

### BRIEF DESCRIPTION OF THE DRAWINGS

FIG. 1 is a schematic visualization of a method, a device, a storage medium and a computer program according to exemplary embodiments of the present invention.

FIG. 2 is a schematic representation of an exemplary traffic scenario between two road users according to exemplary embodiments of the present invention.

FIG. 3 is a schematic representation of an exemplary process sequence according to exemplary embodiments of the present invention.

FIG. 4 is a further representation of an exemplary alternative process sequence according to exemplary embodiments of the present invention.

### DETAILED DESCRIPTION OF EXAMPLE EMBODIMENTS

In the following figures, identical reference signs are also used for the same technical features of different embodiments.

The present invention provides a technical solution for intelligent activation of UWB technology in order to avoid accidents between vehicles and unprotected, vulnerable road users (VRUs) such as bicycles or pedestrians by making precise ranging measurement possible using UWB signals. The present invention makes the activation of UWB tags and distance measurements possible only by prior agreement, as a result of which the limitations of absolute GNSS positions are overcome and positioning inaccuracies are reduced. The method according to the present invention thus aims to provide a method to avoid accidents by intelligently activating the UWB technology when a potentially dangerous situation is recognized.

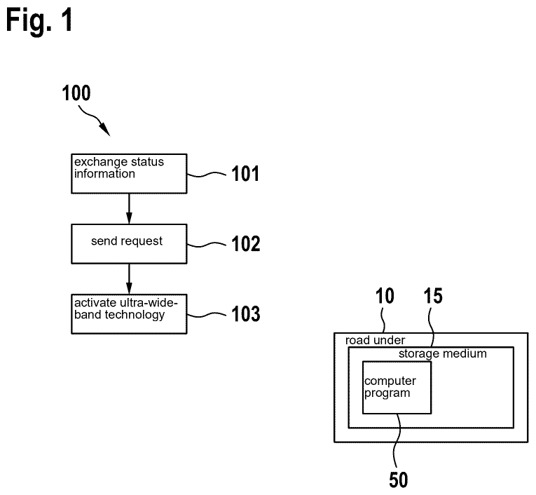

FIG. 1 schematically shows a method 100, a device 10, a storage medium 15, and a computer program 50 according to exemplary embodiments of the present invention. In particular, FIG. 1 shows a method 100 for performing an ultra-wideband-based ranging measurement with at least one other road user 20, which comprises the following steps:

In a first step 101, status information is exchanged, in particular sent and received, with at least one other road user 20 using a V2X message signal, wherein an item of status information comprises at least one indicator with respect to a capability for ultra-wideband-based ranging measurement using ultra-wideband technology of the particular road user 10, 20. In a next step 102, a request is sent to the other road user 20 for performing the ultra-wideband-based ranging measurement with the at least one other road user 20. The message is sent in particular according to a potentially dangerous traffic situation with respect to the two road users 10, 20. In a next step 103, the ultra-wideband technology of the road user 10 is activated for performing the ultra-wideband-based ranging measurement with the at least one other road user 20 on the basis of a received response from the other road user 20 with respect to the request.

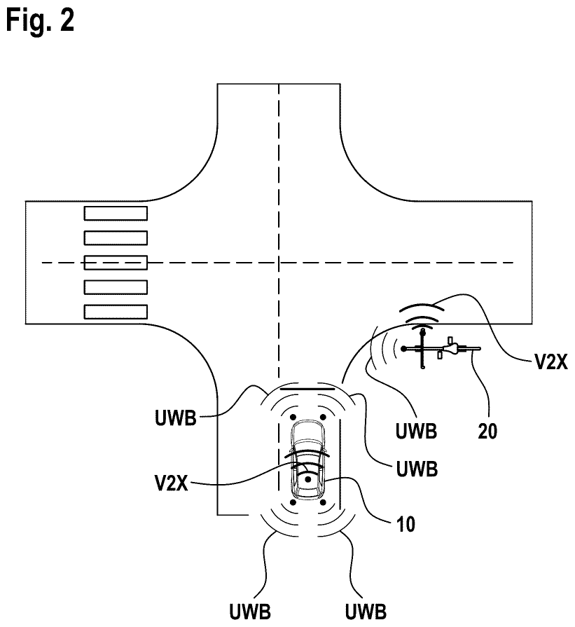

FIG. 2 shows a schematic representation of an exemplary traffic scenario between two road users 10, 20 according to exemplary embodiments of the present invention. FIG. 2 shows a road intersection that two road users 10, 20 are approaching. One road user 10 is shown by way of example as a vehicle 10. The other road user 20 is shown, for example, as a bicycle 20. Each of these road users 10, 20 is equipped with communication technology with which message signals based on V2X technology can be sent and received or exchanged between the road users. This communication technology can be implemented in different modes. A mode can be, for example, a broadcast, a unicast or a groupcast mode as already explained above. Furthermore, in this exemplary embodiment in FIG. 2, both road users 10, 20 are equipped with ultra-wideband (UWB) technology for performing ranging measurements. UWB technology can, for example, comprise at least one UWB unit or at least one UWB tag per road user 10, 20.

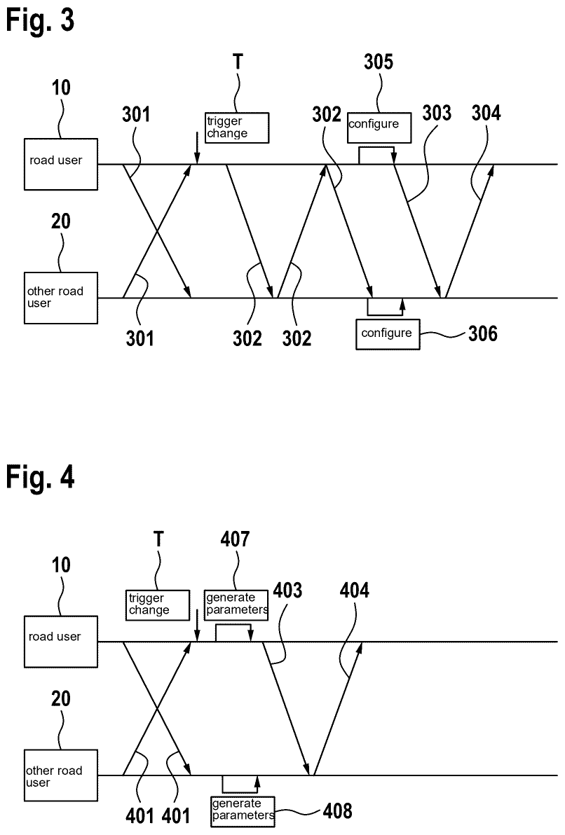

FIG. 3 is a schematic representation of an exemplary process sequence according to exemplary embodiments of the present invention. In this exemplary embodiment according to FIG. 3, two road users 10, 20 are designed as a vehicle 10 and a bicycle 20. The vehicle 10 and the bicycle 20 initially exchange 301 status information. The status information can comprise at least one indicator with respect to a capability for ultra-wideband-based ranging measurement using ultra-wideband technology of the particular road user 10, 20. In this exemplary embodiment, both the vehicle 10 and the bicycle 20 are capable of performing an ultra-wideband-based ranging measurement using a UWB tag. The exchange 301 takes place using a V2X message. If a traffic situation that is potentially dangerous for the vehicle 10 and the bicycle 20, such as, e.g., the particular approach to the same intersection by the vehicle 10, is then anticipated, in this exemplary embodiment this triggers (T) a change from a broadcast-based data exchange to a unicast mode for the two road users 10, 20 or, in the case of more than one other road user, to a groupcast mode, in order to exchange further necessary information regarding the ranging measurement (in each case) directly with one another. For this purpose, there are also various other optional possibilities, e.g. on the basis of the technology (e.g., in C-V2X) or a protocol (e.g., GeoNetworking in ITS-G5).

In this direct and “private” channel, the ultra-wideband (UWB) parameters or all required information can then be exchanged (explicitly) 302 in order to subsequently perform UWB ranging measurements 303, 304. Since ultra-wideband technology requires a unique set of parameters for ranging measurement, this must be known to both road users or both devices and used in the same way 305, 306, such as, e.g., for the particular configuration of the UWB tags. UWB parameters can comprise, for example, an indication about a frequency, symbol duration, security key in the packet header or a preamble of a sent or received unicast message. In other words, a vehicle 10 and a bicycle 20 as a vulnerable road user (VRU) communicate 301 with one another using a broadcast message signal, wherein the communication is based on sending 301 status information. Upon recognizing a potentially dangerous situation, the vehicle 10 sends (T) a request to the VRU 20 in order to initiate a distance measurement using the ultra-wideband (UWB) technology. The VRU 20 responds 302 to the request by sending 302 a response signal to the vehicle. The particular UWB technology is configured 305, 306 accordingly. The vehicle 10 and the VRU 20 then use the response signal in order to determine 303, 304 their relative distance to one another. The vehicle 10 and the VRU 20 can then adjust their actions in real time based on the ascertained distance, as a result of which an accident is prevented or mitigated.

In this exemplary embodiment in FIG. 3, it is advantageous to define when and that both road users 10, 20 activate their UWB ranging measurement at a point in time close to one another. FIG. 4 is a further representation of an exemplary alternative process sequence according to exemplary embodiments of the invention. In contrast to the sequence in FIG. 3, in the exemplary embodiment according to FIG. 4 there is no explicit but instead an implicit exchange of information or data with respect to the performance of the ranging measurement. This means that the vehicle 10 and the bicycle 20 switch from broadcast-based data exchange 401 directly to UWB ranging measurement 403 404. In order for both to know the same unique set of parameters, a uniform method for calculating or generating 407, 408 this set of parameters from a known value can be defined. This can be provided, e.g., by generating a hash with a defined hash function from an identifier or station ID of the particular road user 10, 20. The identifier or station ID uniquely describes the vehicle 10 or the VRU 20. For data protection reasons, this identifier can be changed after a specified time interval. In this optional variant of the exemplary embodiment according to FIG. 4, after such a “pseudonym change” a new unique set of parameters would be generated by both road users 10, 20 due to the changed identifier. Alternatively, it can further be provided that a function other than a hash function or identifiers other than the station ID can be used. Furthermore, the bicycle 20 and the vehicle 10 can also indicate in their particular CAM message with which other road user they are performing or wish to perform a ranging measurement. As a result, in each case the other road user can recognize that a ranging measurement is desired.

In a further exemplary embodiment, an impending pseudonym change for a road user can also be prevented or delayed during an ongoing UWB ranging measurement, since the critical situation and the potential avoidance are given priority over improved data protection.

In the exemplary embodiment in FIG. 4, different points in time could be selected for the vehicle 10 or the bicycle 20 for switching to the UWB ranging measurement, since both 10, 20 can decide this point in time for themselves. Thus, if only one of the two road users considers the situation to be dangerous prior to a collision, this could result in the other user not having activated their UWB chip and ranging measurement not working for either of them. This has to do with the fact that UWB works according to the initiator-response system. Thus, there is an initiator who starts the ranging procedure. A correspondingly configured responder replies to the initiator's message.

A cooperative environment message is also known as a “Cooperative Awareness Messages” (CAM). CAMs are part of the communication technologies for intelligent transport systems (ITS), in particular for connected vehicles, and are standardized for Europe by ETSI (European Telecommunications Standards Institute). They make it possible for vehicles to automatically exchange their current position, direction of movement, speed and other relevant information in real time with other vehicles and infrastructure elements in the vicinity. This serves to increase road safety and avoid traffic accidents. There are similar messages in other geographical regions, for example the Basic Safety Message (BSM) in America or China.

A “VAM message” stands for “Vulnerable Road User Awareness Message” and is a specific type of message within Intelligent Transport Systems (ITS) that focuses on vulnerable road users such as pedestrians and cyclists. These messages are intended to increase the safety of these vulnerable road users by communicating their position and possibly other relevant information (such as direction of movement and speed) to nearby vehicles and traffic infrastructure. This makes improved perception and response by vehicle drivers and automated driving systems possible, in order to avoid potential collisions and improve overall safety in road traffic. There are similar messages in other geographical regions, for example the Personal Safety Message (PSM) in America or China.

In both exemplary embodiments in FIG. 3 and FIG. 4, the request (T) in unicast mode or the UWB request can be initiated by both the vehicle 10 and the bicycle 20. In FIG. 3 and FIG. 4, the particular initiation by the vehicle 10 is shown by way of example.

In the exemplary embodiment in FIG. 3, it may happen that after recognizing a dangerous traffic situation, switching to unicast mode may result in greater complexity and longer delays for the ranging measurement to be performed. This can be avoided or at least significantly reduced by using the exemplary embodiment in FIG. 4.

Triggers for starting a UWB ranging measurement according to the examples in FIG. 3 and FIG. 4 are, for example, intersecting driving trajectories or a relative distance smaller than a threshold value X or a relative speed to one another at which the braking distance is higher than the distance or an inaccurate satellite positioning in an item of status information of a radio message or a restriction of one or more sensors (e.g., an obstacle that restricts the camera's view of the other road user).

TABLE 1

| | | |
|---|---|---|
| Cooperative | Header | ITS Header |
| Awarene [symbol] | cam | CoopAwareness Container |
| | generationDeltaTime | Generation Timestamp |
| | camParameters | Parameters of CAM container |
| | BasicContainer | Contains information about |
| | | station type, position, etc |
| | . . . | For Details see current ETSI |
| | | EN 302 637-2 Standard |
| | HighFrequencyContainer | Contains information about |
| | | speed, heading, etc. with |
| | | high frequency |
| | . . . | For Details see current ETSI |
| | | EN 302 637-2 Standard |
| | LowFrequencyContainer | Contains information about |
| | | exterior lights etc with |
| | | lower frequency |
| | . . . | For Details see current ETSI |
| | | EN 302 637-2 Standard |
| | UwbContainer [optional] | New container for UWB |
| | | information |
| | UwbCapabilities | Capabilities can be: (not- |
| | | available/explicit-switching- |
| | | capable/ |
| | | implicit-switching- |
| | | capable/both-capable/already- |
| | | in-use) |
| | RangingRequestWith [optional] | List of ids which own vehicle |
| | | wants to do UWB ranging with |
| | | (id1, id2, . . . ) |
| | UwbParameters [optional] | Indications on frequency, |
| | | symbol duration, security |
| | | key, preamble |
| | RangingConfirmationWith | Confirmation of a Ranging |
| | [optional] | Request to a certain id |
| | RangingMode [optional] | If own station (e.g. vehicle) |
| | | wants to be initiator or |
| | | responder |
| | RangingSecurity | Information if security is |
| | | used (secured/unsecured) |
| | PotentiallyDangerousSituation | Potentially dangerous |
| | | situation detected where UWB |
| | | can be beneficial |
| | | (true/false) |
| | SpecialVehideContainer | Container for special |
| | | vehicles as ambulances etc |
| | . . . | For Details see current ETSI |
| | | EN 302 637-2 Standard |

[symbol]

indicates data missing or illegible when filed

In Table 1 shown above, a cooperative environment message (CAM) is shown by way of example, which can optionally be extended by a so-called “UWB container.” This UWB container can be comprised in such a CAM message in the so-called LowFrequencyContainer. It is also optionally conceivable that the UWB container is inserted into the so-called HighFrequencyContainer or in the SpecialVehicleContainer (see Table 1). Furthermore, such a UWB container can also be inserted into a VAM message in a similar manner.

The UWB container as shown in Table 1 can comprise one, a plurality of or all of the following information or data fields:
“UWB Capabilities” refers to an indication of the possibilities regarding (its own) UWB ranging measurement capabilities. The content of this field can comprise: not available, explicit exchange, implicit exchange, both exchanges, already in use.
“RangingRequestWith”: this information comprises a request to a certain vehicle identifier (e.g., Station Id) to perform a UWB-based ranging measurement.
“UWB Parameters”: this information comprises a set of parameters (frequency, symbol duration, security key, preamble) that can be selected for the ranging measurement.
“RangingConfirmationWith”: this information comprises a confirmation that a UWB ranging measurement is to be performed with a previously requesting road user.
“RangingMode”: this information comprises whether a station wants to be the initiator or responder for a requested ranging measurement.
“RangingSecurity”: this information comprises whether encryption is used.
“PotentiallyDangerousSituation”: this data field comprises an item of information about whether a potentially dangerous situation that could benefit from ranging measurement is recognized by the road user.

Such an extended CAM message—on the basis of the information listed in Table 1—can be used particularly usefully when communicating in broadcast mode, for example. In broadcast mode, these messages can be periodically exchanged, i.e. sent and received.

In the subsequently listed Table 2, a further optional exemplary embodiment of a UWB container in a standalone message, such as, e.g., a special or specific ranging message, is shown. This message can also be referred to as a so-called “UWB Ranging Message (URM)” and can be structured according to the structure shown in Table 2.

The content of the UWB container comprises the same information as the corresponding data fields of the UWB container in Table 1 above. In particular, the URM message can be used in a V2X unicast or groupcast message signal. This makes better efficiency possible in an explicit exchange mode between road users, since only a few users receive such messages and the general information of the CAM message is not necessary.

TABLE 2

| | | |
|---|---|---|
| UWB | Header | ITS Header |
| Ranging | urm | UWB Ranging Container |
| Message | UwbCapabilities | Capabilities can be: (not- |
| (URM) | | available/explicit-switching- |
| | | capable/ |
| | RangingRequestWith | List of ids which own vehicle |
| | [optional] | wants to do UWB ranging |
| | | with (id1, id2, |
| | UwbParameters [optional] | Indications on frequency, |
| | | symbol duration, security key, |
| | | preamble |
| | RangingConfirmationWith | Confirmation of a Ranging |
| | [optional] | Request to a certain id |
| | RangingMode | If own station (e.g. vehicle) |
| | | wants to be initiator or |
| | | responder |
| | RangingSecurity | Information if security is |
| | | used (secured/unsecured) |
| | | Potentially dangerous |
| | | situation detected where UWB |
| | | can be beneficial |
| | PotentiallyDangerousSituation | (true/false) |

The above description of the embodiments describes the present invention exclusively in the context of examples. Of course, individual features of the embodiments, provided they make technical sense, can be freely combined with one another without departing from the scope of the present invention.

What is claimed is:

1. A method for performing an ultra-wideband (UWB)-based ranging measurement of a road user with at least one other road user, the method comprising the following steps:
exchanging status information using a V2X message signal between the road user and the at least one other road user, wherein an item of the status information includes at least one indicator with respect to a capability for ultra-wideband-based ranging measurement using ultra-wideband technology of the particular road user;
sending a request from the road user to the other road user for performing the ultra-wideband-based ranging measurement with the at least one other road user, wherein the message is sent in according to a potentially dangerous traffic situation with respect to the road user and the other road user; and
activating the ultra-wideband technology of the road user for performing the ultra-wideband-based ranging measurement with the at least one other road user based on a received response from the other road user with respect to the request.

2. The method according to claim 1, wherein the the method further comprises the following steps:
exchanging a set of parameters for configuring the ultra-wideband technology to be used with the at least one other road user using unicast-based communication or groupcast-based communication;
configuring the ultra-wideband technology based on a set of parameters of the at least one other road user; and
providing the ultra-wideband technology for the ultra-wideband-based ranging measurement by the road user.

3. The method according to claim 1, wherein, during the exchange, the status information includes a common indication valid for the road user and the at least one other road user for configuring the ultra-wideband-based technology of the road user, and wherein the method further comprising the following steps:
generating a set of parameters for configuring the ultra-wideband technology to be used based on the valid, common indication;
configuring the ultra-wideband technology to be used based on the generated set of parameters; and
providing the ultra-wideband technology for the ultra-wideband-based ranging measurement by the road user at the at least one other road user.

4. The method according to claim 3, wherein the valid, common indication includes a configuration parameter and/or a road user identifier in order to generate the set of parameters for configuring the ultra-wideband technology of the road user that is to be used.

5. The method according to claim 1, the method comprising the the following step:
recognizing the potentially dangerous traffic situation with respect to the road user and the at least one other road user in order to send the request to perform the ultra-wideband-based ranging measurement, wherein the potentially dangerous traffic situation is specified by the occurrence of an intersecting lane with the at least one other road user and/or by a relative distance to the at least one other road user that is smaller than a defined threshold value for the road user and/or by inaccurate satellite positioning in an item of status information of a radio message and/or by a limitation of one or more sensors of the road user.

6. The method according to claim 1, further comprising the following steps:
performing the ultra-wideband-based ranging measurement by the road user in order to ascertain a more accurate distance between the road user and the at least one other road user; and
adjusting an action of the road user in real time based on the ascertained distance in order to avoid the potentially dangerous traffic situation.

7. The method according to claim 1, wherein the V2X message signal includes: a cooperative environment message including a Cooperative Awareness Message (CAM) message, and/or a message for perception of unprotected road users including a Vulnerable Road User Awareness Message (VAM) message, and/or a specific ranging measurement message including a UWB Ranging Message (URM) message.

8. The method according to claim 1, wherein the status information includes further information about the road user regarding a current position and/or direction of movement and/or speed.

9. A device for processing data, the device configured to perform an ultra-wideband (UWB)-based ranging measurement of a road user with at least one other road user, the device configured to:
exchange status information using a V2X message signal between the road user and the at least one other road user, wherein an item of the status information includes at least one indicator with respect to a capability for ultra-wideband-based ranging measurement using ultra-wideband technology of the particular road user;
send a request from the road user to the other road user for performing the ultra-wideband-based ranging measurement with the at least one other road user, wherein the message is sent in according to a potentially dangerous traffic situation with respect to the road user and the other road user; and
activate the ultra-wideband technology of the road user for performing the ultra-wideband-based ranging measurement with the at least one other road user based on a received response from the other road user with respect to the request.

10. A non-transitory computer-readable storage medium on which are stored commands for performing an ultra-wideband (UWB)-based ranging measurement of a road user with at least one other road user, the commands, when executed by a computer, causing the computer to perform the following steps:
exchanging status information using a V2X message signal between the road user and the at least one other road user, wherein an item of the status information includes at least one indicator with respect to a capability for ultra-wideband-based ranging measurement using ultra-wideband technology of the particular road user;
sending a request from the road user to the other road user for performing the ultra-wideband-based ranging measurement with the at least one other road user, wherein the message is sent in according to a potentially dangerous traffic situation with respect to the road user and the other road user; and
activating the ultra-wideband technology of the road user for performing the ultra-wideband-based ranging measurement with the at least one other road user based on a received response from the other road user with respect to the request.

11. A data structure for a message for transmission in a radio communication system, including at least one data field representing an indicator with respect to a capability for ultra-wideband (UWB)-based ranging measurement using ultra-wideband technology, wherein the message is configured as a cooperative environment message including a Cooperative Awareness Message (CAM) message, or a message for perception of vulnerable road users including a Vulnerable Road User Awareness Message (VAM) message, or a specific ranging measurement message including a (UWB Ranging Message) URM message.
